(19) United States
(12) Patent Application Publication
(10) Pub. No.: US 2014/0082385 A1
(43) Pub. Date: Mar. 20, 2014

(54) ON DEMAND POWER MANAGEMENT FOR SOLID-STATE MEMORY

(71) Applicants: Curtis G. Reule, Fargo, ND (US); Tyler A. Laber, Fargo, ND (US); Tristan M. Simetkosky, Dilworth, MN (US); Joel A. Jorgenson, Fargo, ND (US)

(72) Inventors: Curtis G. Reule, Fargo, ND (US); Tyler A. Laber, Fargo, ND (US); Tristan M. Simetkosky, Dilworth, MN (US); Joel A. Jorgenson, Fargo, ND (US)

(21) Appl. No.: 13/796,076

(22) Filed: Mar. 12, 2013

Related U.S. Application Data
(60) Provisional application No. 61/701,330, filed on Sep. 14, 2012.

(51) Int. Cl. G06F 1/26; G06F 1/32

(52) U.S. Cl. CPC G06F 1/266; G06F 1/3268
USPC 713/320; 713/300

(57) ABSTRACT

Embodiments of an apparatus to increase the power efficiency of a solid-state memory have been presented. In one embodiment, the apparatus includes a power detection circuit coupled to the solid-state memory to detect a demand of a power distribution network that supplies power to the solid-state memory. Furthermore, the apparatus may include a power management controller coupled to the power detection circuit to receive the demand and to scale a voltage supply to the power distribution network in response to the detected demand.

### RELATED APPLICATIONS

This application claims the benefit of U.S. Provisional Application No. 61/701,330, filed Sep. 14, 2012, the entire contents of which is hereby incorporated by reference.

### TECHNICAL FIELD

The present invention relates generally to power management and in particular to methods and systems to improve the power efficiency of solid-state memory including but not limited to synchronous dynamic random access memory (e.g. DDR, DDR2, DDR3).

### BACKGROUND

Conventionally, solid-state memory in many computing systems is powered by a constant voltage. FIG. 1 illustrates a typical conventional electrical system 100. The system 100 includes solid-state memory 160, a fixed voltage regulator 120 and a host controller 140. The host controller 140 is coupled to a data port 166 of the solid-state memory 160 to send data to and/or receive data from the solid-state memory 160. The fixed voltage regulator 120 is coupled to a power port 164 of the solid-state memory 160 to supply a constant voltage to the solid-state memory 160. During operation, the fixed voltage regulator 120 supplies the same constant voltage to the solid-state memory 160 regardless of the actual power demand of the solid-state memory 160.

### BRIEF DESCRIPTION OF THE DRAWINGS

The present invention is illustrated by way of example, and not of limitation, in the figures of the accompanying drawings in which:

FIG. 1 illustrates a system level diagram for one conventional electrical system including solid-state memory, a fixed voltage regulator, and a host controller.

FIG. 2 illustrates an embodiment of a system for voltage scaling of a solid-state memory to reduce power consumption.

FIG. 3 illustrates an embodiment of a system for voltage scaling of a solid-state memory to reduce power consumption.

FIG. 4 illustrates an embodiment of a power detection circuit to determine when the current draw of the solid-state memory exceeds a programmable threshold.

FIG. 5 illustrates one embodiment of a state diagram of a state machine usable in embodiments of a power management controller.

FIG. 6 illustrates another embodiment of a state diagram of a second state machine usable in embodiments of a power management controller.

FIG. 7 illustrates one embodiment of a timing diagram related to the state machine of the state diagram illustrated in FIG. 5.

FIG. 8 illustrates one embodiment of a timing diagram related to the state machine of the state diagram illustrated in FIG. 6.

FIG. 9 illustrates another embodiment of a timing diagram related to the state machine of the state diagram illustrated in FIG. 6.

FIG. 10 illustrates a diagrammatic representation of a machine in the exemplary form of a computing system for solid-state memory power management.

### DETAILED DESCRIPTION

The following embodiments of the invention relate to a system and an apparatus to increase the power efficiency of solid-state memory, such as DDR memory. More specifically, embodiments of the present invention relate to a system and an apparatus to dynamically adjust a power supply in accordance with the real-time application demands of solid-state memory in order to improve the overall power efficiency of the system.

In the following description, numerous specific details are set forth such as examples of specific components, devices, methods, etc., in order to provide a thorough understanding of embodiments of the present invention. It will be apparent; however, to one skilled in the art that these specific details need not be employed to practice embodiments of the present invention. In other instances, well-known materials or methods have not been described in detail in order to avoid unnecessarily obscuring embodiments of the present invention.

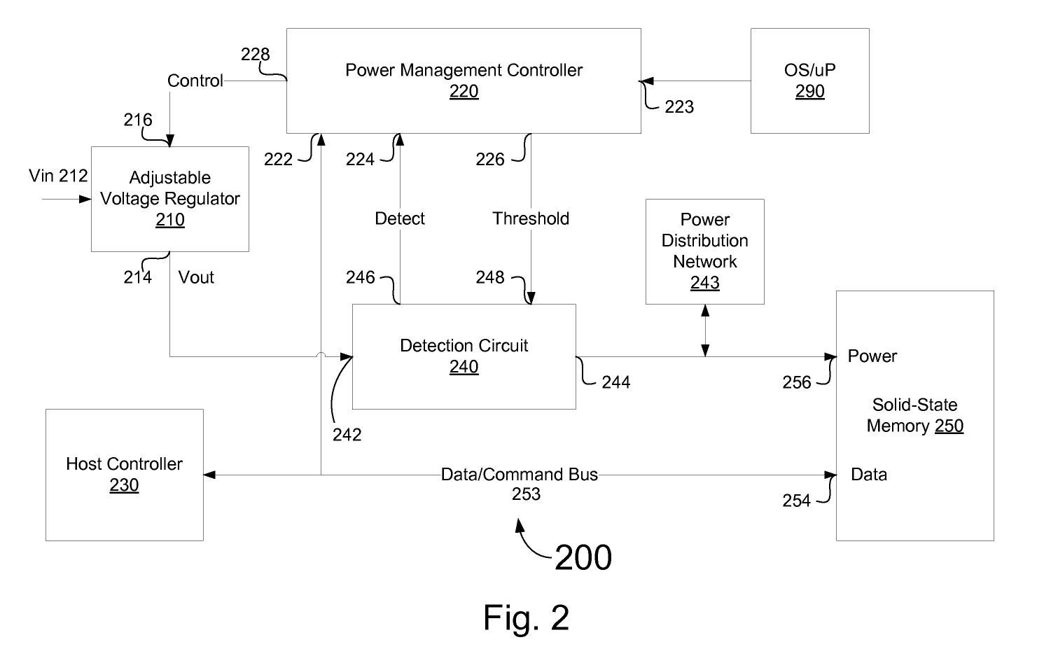

FIG. 2 illustrates one embodiment of a system 200 for voltage scaling of a solid-state memory 250. The system 200 includes an adjustable voltage regulator 210 (hereinafter “AVR 210”), a host controller 230, a power management controller 220 (hereinafter “PMC 220”), a power detection circuit 240 (hereinafter “PDC 240”), a power distribution network 243, and a solid-state memory 250. In some embodiments, the power detection circuit 240 is a current detection circuit that detects current demand of the power distribution network 243 that supplies power to the solid-state memory 250. In another embodiment, the power detection circuit 240 is an analog detection circuit that can detect one or more analog signals, such as voltage signals, to determine the power demand of the power distribution network 243 that supplies power to the solid-state memory 250. The PMC 220 includes a data port 222, a digital activity port 223, a detection input 224, a threshold output 226, digital input from an operating system or a microprocessor 290 (OS/uP) and a control output 228. The solid-state memory 250 includes a data port 254 and a power input 256. The power detection circuit 240 includes a power input 242, a power output 244, a detect output 246 and a threshold input 248. The AVR 210 includes a voltage input 212, an adjustable voltage output 214 and a control input 216.

In some embodiments, the solid-state memory 250 is a synchronous dynamic random-access memory (SDRAM), such as double data rate memory (e.g., DDR1, DDR2 and DDR3). The embodiments described herein may be used with DDR memory on one or more dual in-line memory modules (DIMMs). Alternatively, other memory modules may be used. In one embodiment, the voltage regulator 210 is placed on the memory module. The voltage regulator 210 may be a switching regulator, a low-dropout (LDO) regulator or the like. In another embodiment, the solid-state memory 250 is a flash memory. In another embodiment, the solid-state memory 250 is a graphic SDRAM (e.g., GDDR2, GDDR3, GDDR4, and GDDR5). Alternatively, the solid-state memory 250 may be other types of solid-state memory, such as SRAM or magnetoresistive random-access memory (MRAM), as would be appreciated by one of ordinary skill in the art having the benefit of this disclosure.

In some embodiments, the power detection circuit 240 may be part of the AVR 210. Alternatively, the power detection circuit 240 may be on the same integrated circuit (IC) as the PMC 220, or on a separate IC as the PMC 220. Furthermore, the PMC 220 may be located inside or outside of the solid-state memory 250. The AVR 210 may be located inside or outside of the solid-state memory 250 or on the same or separate IC as the PMC 220. Other physical locations of the power detection circuit 240, the AVR 210 and the PMC 220 may be utilized.

Referring to FIG. 2, the control output 228 of the PMC 220 is connected to the control input 216 of the AVR 210. The adjustable output voltage 214 of the AVR 210 is connected to the power input 242 of the power detection circuit 240. The PMC 220 receives detect signals from the detect output 246 of the power detection circuit 240 and sends threshold signals from the threshold output 226 to the threshold input 248 of the power detection circuit 240. The power output 244 of the power detection circuit 240 is connected to the power input 256 of the solid-state memory 250. Optionally, the data port 254 of the solid-state memory 250, the host controller 230 and the data port 222 of the PMC 220 are all connected to the bus 253 (e.g., a data bus or a command bus, hereinafter data/command bus). The host controller 230 is in bidirectional communication with the solid-state memory 250 through the data/command bus 253. The PMC 220 monitors the communication on the data/command bus 253 through the data/command bus interface at data port 222. In the embodiments described herein, thresholds are used. In other embodiments, other metrics could be used, such as instantaneous rate of current change. The PMC 220 may implement a state machine to transition between multiple states in response to the demand detected by the power detection circuit 240. The states may be associated with operation states of the solid-state memory 250. For example, the solid-state memory 250 may include one or more states, like a fully-on state, an off state, and one or more intermediate power states. The states may also be associated with power states of a computing system, such as power states, global states, device states, performance states or the like. For example, in order to save energy when the CPU is idle, the CPU can be commanded to enter a low-power mode (sometimes called C-states).

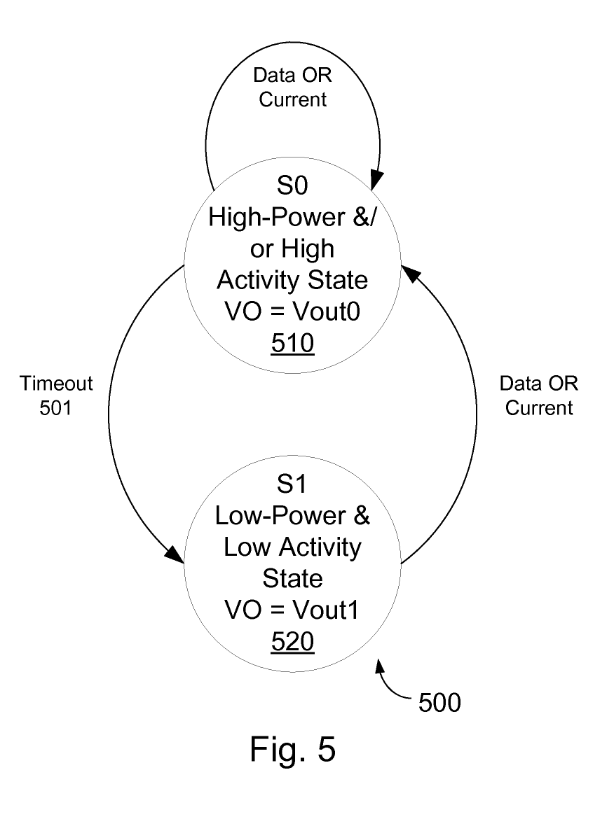

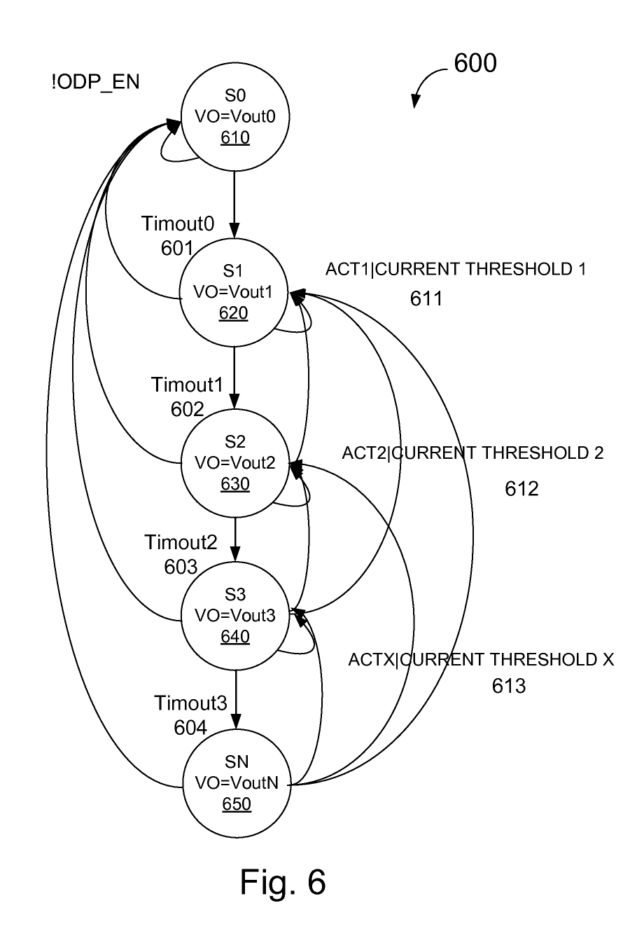

In one embodiment, the PMC 220 could measure the rate of current change and determine from a previous known level whether states need to change from S1 to S0 (illustrated in FIG. 5). In another embodiment, the PMC 220 could measure the rate of current change and determine from a previous known level whether states need to change from Sn to Sn−1 (illustrated in FIG. 6). Alternatively, the PMC 220 could determine whether to change from one state to another as described herein in various embodiments. Instead of using a current threshold to determine whether to change the state, the PMC 220 could use a current rate of change threshold and could change states when the rate of current change goes above or below the current rate of change threshold (e.g. the current changing to quickly or slowly, like a large current transient or high di/dt event). Alternatively, the PMC 220 can use the rate of current change in addition to other methods to determine whether to change states or not as would be appreciated by one of ordinary skill in the art having the benefit of this disclosure.

In one embodiment, the PMC 220 implements a power management state machine (some embodiments of which are discussed later with reference to FIGS. 5-6) that determines the appropriate input supply voltage for the solid-state memory 250 depending on the detected activity of the solid-state memory 250 and causes the AVR 210 to dynamically adjust the output voltage 214 connected to the power input 256 of the solid-state memory 250 through the power detection circuit 240. The PMC 220 controls the output voltage 214 of the AVR 210 that supplies power to the solid-state memory 250 to reduce the total power consumption of the solid-state memory 250. The PMC 220 controls the mode of operation of the AVR 210 based on the detected demand, such as the electrical current drawn by the solid-state memory 250, electrical current drawn by the power distribution network 243, current drawn by or the rate at which the current is drawn by the solid-state memory 250, communication on the data/command bus 253, operating temperature of the solid-state memory 250, or any combination thereof. In some embodiments, the AVR 210 may operate in one or more modes, such as a switching regulator in PWM (pulse width modulation) mode, a switching regulator in PFM (pulse frequency modulation) mode, and an LDO (low dropout DC linear voltage regulator) mode, for example. In another embodiment, the solid-state memory 250 may operate in a high performance mode at a first frequency and a first voltage (e.g., VDDQ) and a power savings mode at a second frequency that is lower than the first frequency and a second voltage that is less than the first voltage. The PMC 220 can determine the real-time application demand of the solid-state memory 250 and can switch between the performance mode and the power savings mode. In summary, the PMC 220 dynamically adjusts the voltage output 214 of the AVR 210 to accommodate the real-time application demand of the solid-state memory 250 to improve power efficiency.

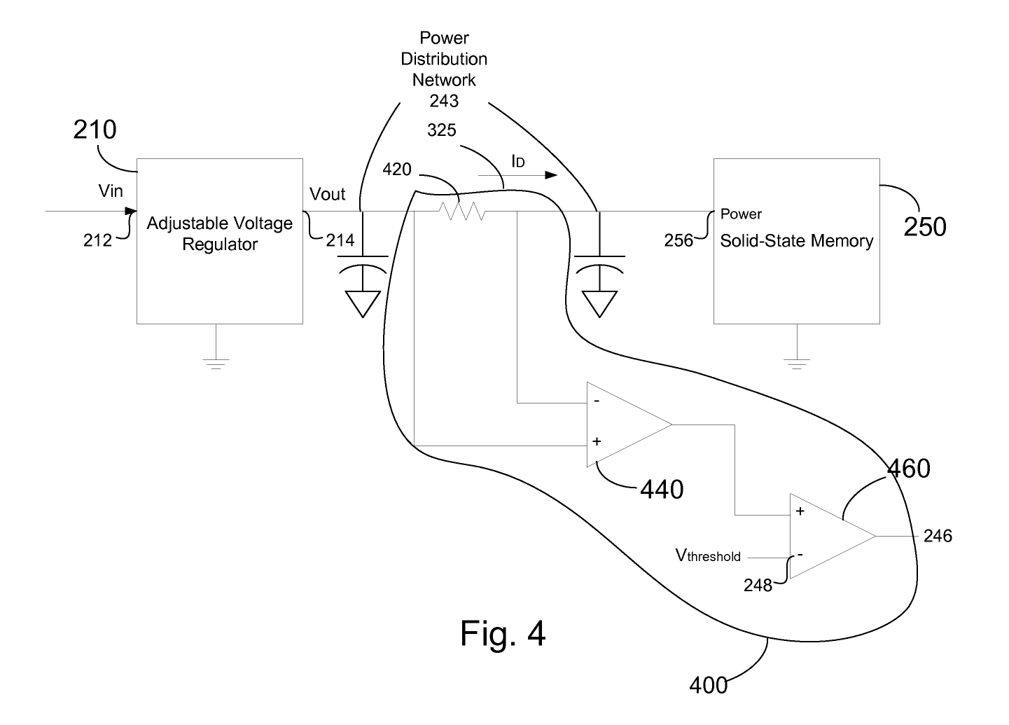

In some embodiments, the power input 242 of the power detection circuit 240 (hereinafter “PDC 240”) receives power from the AVR 210 and forwards the power through the power output 244 to the power input 256 of the solid-state memory 250. In one embodiment, the PDC 240 includes a power detection circuit (e.g., 400 of FIG. 4). Alternatively, other parameter detection devices may be used. A power detection circuit is used to determine when a parametric value exceeds a programmable threshold 248, which is provided by the PMC 220. In one embodiment, the PDC 240 receives the threshold data from the PMC 220 to be used as a reference value for the comparator of PDC 240, which is further discussed below with reference to FIG. 4. In one embodiment, the PDC 240 detects a parameter associated with the power received from the AVR 210, compares the parameter to the programmable threshold 248 received from the PMC 220, and delivers the result to the detection input 224 of the PMC 220. In another embodiment, the PDC 240 detects a demand of the power distribution network 243 that supplies power to the solid-state memory 250, compares the demand to one or more programmable thresholds, and delivers the result to the detection input 224 of the PMC 220. The parameter detected by the PDC 240 may be at least one of several parameters, such as electrical current, voltage potential, etc. In another embodiment, the detected parameters received from the PDC 240 allow the PMC 220 to determine the state of operation of the solid-state memory 250. Based on the state of operation, the PMC 220 may dynamically adjust the output voltage 214 of the AVR 210 to accommodate that particular state of operation in a more power efficient manner. For example, in a state that requires a lower voltage supply, the PMC 220 may cause the AVR 210 to lower the voltage supply to the solid-state memory 250. When the solid-state memory 250 transitions to a state that requires a higher voltage supply, the PMC 220 may cause the AVR 210 to increase the voltage supply to the solid-state memory 250. Some embodiments of the process to dynamically adjust the power supply to the solid-state memory 250 are discussed in detail below.

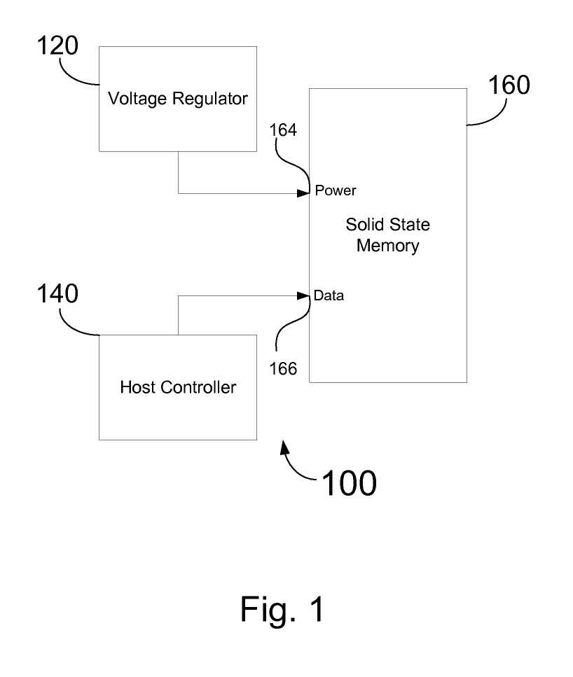

In one embodiment, the host controller 230 of FIG. 2 controls and communicates with the solid-state memory 250 through the data/command bus 253. For example, the solid-state memory 250 may have several different modes of operation, each with different demands for energy. This, in turn, allows the various different operations to be optimized for power efficiency by varying the voltage outputs from the AVR 210. The PMC 220 may dynamically adjust the output voltage 214 of the AVR 210 based on the communication monitored at the data port 222 on the PMC 220. For example, the PMC 220 may monitor the communication between the host controller 230 and the solid-state memory 250 to identify the different commands from the host controller 230 that cause the solid-state memory 250 to enter different modes of operation. Communications between the host controller 230 and the solid-state memory 250 may include toggling of a chip select, rising or falling edges of a digital I/O line interfacing the solid-state memory 250 to the host controller 230, sleep signals which are sent from the host controller 230 to the original voltage regulator (120 in FIG. 1), and specific commands and data sent between the host controller 230 and the solid-state memory 250, etc. Such communication may be decoded by the PMC 220 to determine if a particular event requires the PMC 220 to adjust the voltage delivered to the solid-state memory 250 by the AVR 210. The PMC 220 may then dynamically adjust the output voltage 214 of the AVR 210 to more efficiently accommodate the voltage requirement of each state with a more power efficient voltage setting. In some embodiments, the host controller 230 may include a memory controller or a central processing unit.

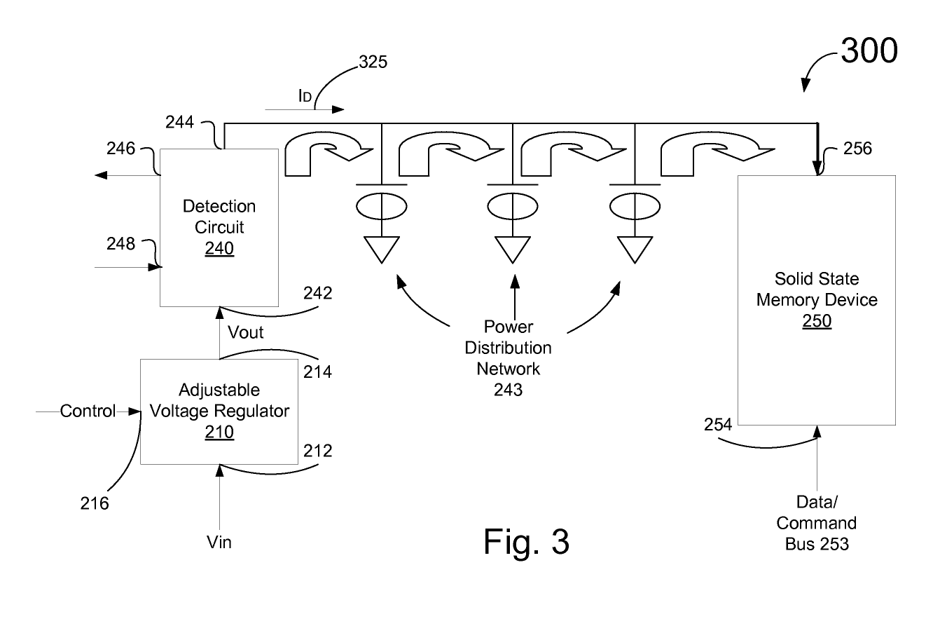

In one embodiment, the voltage regulator 210 does not directly power the solid-state memory 250; rather a power distribution network, described in more detail below with respect to FIG. 3, are used to delivery high-frequency current to the solid-state memory 250. The power distribution network 243 is a network containing a variety of elements, such as capacitors, ferrite beads, etc., to improve integrity of power rails. In one embodiment, the power distribution network includes bulk capacitors. Alternatively, the power distribution network may include other types of power distribution capacitors such as bypass capacitors. Bulk capacitors are usually used at the point of source, as opposed to bypass capacitors that are usually used at the point of load. In these embodiments, the PMC 220 of FIG. 2 senses the current demand (e.g., current demand 325, (hereinafter “I_{D} 325”) described with respect to FIG. 3) on the power distribution network 243, and not on the solid-state memory 250 itself, and responds in time to keep the solid-state memory 250 operating. It should be noted that the current demand is one type of parameter that can be used to measure the power demand of the power distribution network 243. However, in other embodiments, other parameters of the power demand on the power distribution network 243 can be measured and the power can be adjusted accordingly for the solid-state memory 250. In one embodiment, the solid-state memory 250 is DDR3 memory, which uses 1.5V with a worst-case current of 5 amps (equivalent resistance of 0.3 ohms), such as when transitioning from load step to open circuit. In this scenario, the DDR3 memory uses 470 μF bulk capacitance. The first order RC time constant is approximately 140 μsec. The PMC 220 and power detection circuit 240 may be configured to operate magnitudes faster than the first order RC time constant. As such, the PMC 220 may dynamically manage the power for the DDR3 memory, yet respond in time to keep the DDR3 memory operating.

In other embodiments, a digital activity signal can be received at the digital activity port 223 of the PMC 220. The digital activity signal may be received from an operating system (OS) executing on a processor 290 or from the processor 290. For example, in one embodiment, the digital activity signal may be an OS driven sleep state, such as the Windows 8 connected standby state or the like. The digital activity signal can be used by the PMC 220 to put the solid-state memory 250 in a lower power state as would be appreciated by one of ordinary skill in the art having the benefit of this disclosure.

FIG. 3 illustrates one embodiment of a system 300 for voltage scaling of a solid-state memory 250. System 300 is similar to system 200 as noted by similar reference numbers. For example, the system 300 includes an AVR 210, a power detection circuit 240 and the solid-state memory 250. The power detection circuit 240 includes a power input 242, a power output 244, a detect output 246 and a threshold input 248. The solid-state memory 250 also includes a data port 254 and a power input 256. The AVR 210 includes a voltage input 212, an adjustable voltage output 214 and a control input 216. The system 300 illustrates measuring the current demand I_{D} 325 on the power distribution network 243. The PMC 220 (not illustrated in FIG. 3) senses the current demand I_{D} 325 on the power distribution network 243, and not on the solid-state memory 250 itself, and responds in time to keep the solid-state memory 250 operating. In one embodiment, the PMC 220 (not illustrated in FIG. 3) sends one or more control signals to the control input 216 of the AVR 210 via a control output and threshold data to a threshold input 248 of the power detection circuit 240 via a threshold output. The AVR 210 sends an output voltage 214 to the input power 242 of the power detection circuit 240, which forwards the output voltage via the power output 244 to power distribution network 243, which supplies the input voltage to the power port 256 of the solid-state memory 250. The power detection circuit 240 may send one or more detect signals to the PMC 220 (not illustrated in FIG. 3) via a detect output (not illustrated in FIG. 3). The solid-state memory 250 may be in bidirectional communication with a host controller via a data/command bus, and the PMC may be coupled to the data/command bus to monitor communication on the data/command bus.

In some embodiments, the power detection circuit 240 includes a filter to screen out noise on the power lines. Many mechanisms may be incorporated to implement noise filters where there is no appreciable delay added to the valid detection of current. It is also important to note that the components of the power distribution network are non-ideal. For example, capacitors contain parasitic ESR (equivalent series resistance) and ESL (equivalent series inductance). A side effect of ESR is that the voltage rail is reduced by the product of the ESR and the current supplied by the capacitor. With the proper power detection circuit, voltage drops caused by sudden current demand could be minimized by the proactive nature of the apparatus described. The apparatus is also capable of decreasing the impact of other non-idealities of the power distribution network 243.

In one embodiment, the programmable threshold of the power detection circuit 240 is set such that the current draw I_{D} 325 by the power distribution network 243 is greater than a current threshold associated with a reference threshold voltage received at the threshold input (not illustrated in FIG. 3).

The power detection circuit 240 may be located inside or outside of the solid-state memory 250. In some embodiments, the power detection circuit 240 may be part of the AVR 210. Alternatively, the power detection circuit 240 may be on the same IC as the PMC 220, or on a separate IC as the PMC 220. Furthermore, the PMC 220 may be located inside or outside of the solid-state memory 250. The AVR 210 may be located inside or outside of the solid-state memory 250 or on the same or separate IC as the PMC 220. Other physical locations of the power detection circuit 240, the AVR 210 and the PMC 220 may be utilized.

FIG. 4 illustrates an embodiment of a power detection circuit 400 to determine when the current draw of a solid-state memory 250 exceeds a programmable threshold 248. The power detection circuit 400 may be the power detection circuit 240 of FIG. 2. Alternatively, the power detection circuit 240 may be other types of power detection circuits as would be appreciated by one of ordinary skill in the art having the benefit of this disclosure. The power detection circuit 400 includes a sense resistor (Rsense) 420 (or other resistive type elements, such as the resistive characteristics of other components, including, for example, a metal-oxide-semiconductor field-effect transistor (MOSFET), inductor direct current resistance (DCR), output capacitor equivalent series resistance (ESR), or the like), a differential amplifier with gain 440, and a voltage comparator 460. Additionally, the power detection circuit 400 may be interfaced to the adjustable voltage output 214 of the AVR 210 and the power distribution network 243, which are coupled to the power input 256 of the solid-state memory 250. The solid-state memory 250 has a power input 256 and an electrically grounded return path. The AVR 210 has a voltage input 212, a voltage output 214, a control input (not illustrated), and an electrically grounded return path. It should be noted that the power distribution network 243 can include one or more power distribution capacitors on either side of the sense resistor 420 or both.

In one embodiment, the input of the AVR 210 may be the control output from the PMC 220 as depicted in FIG. 2. The AVR 210 output voltage 214 is in electrical connection with both Rsense 420 and the positive input of the differential amplifier 440. The opposite end of Rsense 420 is in electrical connection with both the power input 256 of the solid-state memory 250 and the negative input of the differential amplifier 440. The output of the differential amplifier 440 is in electrical connection with the positive input of the voltage comparator 460. A threshold reference voltage 248 is applied to the negative input of the voltage comparator 460. The threshold reference voltage 248 is typically provided by the PMC 220 via the threshold output. The output of voltage comparator 460 may be connected to the current detect input of the PMC 220 according to one embodiment. As described herein, the current detect input is one of many types of activities that can be detected. In another embodiment, the output of the differential amplifier 440 is in electrical connection with the negative input of the voltage comparator 460. A threshold reference voltage 248 is applied to the positive input of the voltage comparator 460.

In operation, the AVR 210 provides power to the power distribution network 243 (also referred to as the power distribution capacitors or bulk capacitance), and the power distribution network 243 provide the power to the solid-state memory 250. The voltage output 214 of the AVR 210 is dynamically adjusted in accordance to the amount of current I_{D} 325 drawn by the power distribution network 243. I_{D} 325 passes through Rsense 420, which then develops a voltage across its terminals. This voltage may be differentially filtered to remove unwanted noise before being differentially applied to the differential amplifier 440. In another embodiment, the differential amplifier 440 can be configured to filter unwanted noise and amplify. The output of the differential amplifier 440 is typically the voltage across Rsense 420 multiplied by a programmable gain value. The gain value is the amount of amplification that the differential amplifier 440 provides to its differential input signals. In one embodiment, the gain of the differential amplifier 440 may be set through peripheral component selection. The differential amplifier 440 may include a variety of electronic components, such as operational amplifiers, ICs, discrete components, etc.

The output of the differential amplifier 440 feeds into the positive input of the comparator circuit 460. A threshold voltage 248 is applied to the negative terminal of the comparator circuit 460. For example, this threshold voltage 248 may be supplied by a PMC (e.g., the PMC 220 in FIG. 2) and may be fully programmable via automated test equipment (ATE), host controller, algorithms within PMC, or the like. The comparator circuit 460 provides a logic output high or low depending on the relationship between the signals at its differential input. For example, in one embodiment, a logic high output may result if the current I_{D} 325 multiplied by the resistance of Rsense 420 and the gain of the differential amplifier 440 is greater than the programmable threshold voltage 248. The logic output (a.k.a. current detect signal) 462 of the comparator circuit 460 feeds into the PMC. The PMC adjusts the output voltage 214 of the AVR 210 accordingly via the control input 216.

The voltage comparator 460 may be implemented using discrete components, integrated circuits, etc. Other power detection circuits may also be used to allow the PMC to differentiate different modes of operation in different embodiments.

FIG. 5 illustrates one embodiment of a state diagram 500 of a state machine usable in some embodiments of the PMCs discussed above. The state machine includes two states: a low power and low activity state 520 and a high power and/or high activity state 510. Because of the small number of states, the state machine is better utilized for applications that require simplicity of operation and ease of implementation.

The low power and low activity state 520 includes the following modes of operation of a solid-state memory when there is no high power event of the solid-state memory; when there is no pertinent communication between the solid-state memory and the host controller; and no access of the host controller. In other embodiments, idle and sleep modes may also be used.

In one embodiment, the high power and/or high activity state 510 includes any of the following or any combination thereof: when there is communication between the solid-state memory and the host controller; the host controller accessing the solid-state memory; or any high power event of the solid-state memory.

In one embodiment, the state machine transitions from the high power and/or high activity state 510 to the low power and low activity state 520 in response to a timeout 501. A timeout 501 event occurs when a data or current event has not been detected for a specified amount of time. The period of the timeout is chosen to not prematurely transition from the high power and/or high activity state 510 to the low power and low activity state 520 in the event that data or current event signals are not constant due to noise or other aberration Likewise, the timeout period should be sufficiently short to ensure a transition from the high power and/or high activity state 510 to the low power and low activity state 520 in a reasonable amount of time after all detected current and data events have come to completion. In one embodiment, the state machine transitions from the low power and low activity state 520 to the high power and/or high activity state 510 in response to detection of certain communication data. For example, the data may include a read or a write event detected on a data/command bus connecting the solid-state memory to the host controller. Alternatively, when the current draw of the solid-state memory has exceeded a predetermined current threshold (which may be determined as discussed above with reference to FIG. 4), the state machine may also transition from the low power and low activity state 520 to the high power and/or high activity state 510. The low power and low activity state 520 and the high power and/or high activity state 510 are associated with supply voltages Vout1 and Vout0, respectively. In one embodiment, supply voltage Vout0 is greater than or equal to supply voltage Vout1.

In some embodiments, the PMC 220 directs the AVR 210 to increase the input supply voltage of the solid-state memory such that high current events in the solid-state memory do not cause a brownout of the power supply while the state machine 500 is in the high power and/or high activity state 510. The PMC 220 also adjusts the input supply voltage of the solid-state memory 250 to ensure that there are adequate noise margins for communication between the solid-state memory 250 and the host controller 230 as well as any internal communication within the solid-state memory 250. This may be done by detecting the current drawn I_{D} 325 by the power distribution network 243 and dynamically adjusting the voltage level of the power distribution network 243. While in the low power and low activity state 520, the PMC 220 may instruct the AVR 210 to decrease the input supply voltage 214 provided to the power distribution network 243, which supply the solid-state memory 250, such that the power consumption of the solid-state memory 250 is reduced.

In some embodiments, a time delay is added to the transition from the high power and/or high activity state 510 to the low power and low activity state 520. The time delay may prevent a transition to the low power and low activity state 520 when the requirements for transition are only valid for a short period. The power loss associated with changing states and supply voltages may be greater than the power lost by remaining in the high power and/or high activity state 510 for a longer period than required by the high power event. The length of the time delay may be chosen to balance power savings and latency. The time delay may be calculated using a deterministic or probabilistic lower envelope algorithm.

FIG. 6 illustrates another embodiment of a state diagram 600 of a second state machine usable in embodiments of a power management to improve power efficiency of solid-state memory 250. The state machine includes N states: S0 610, S1 620, S2, 630, S3 640, and SN 650. There are N−1 timeout events, labeled timeouts 601-604. It should be noted that depicted embodiment illustrates five states with four timeout events and three current detect thresholds (also referred to as activity thresholds): ACT 1|current_threshold1 611, ACT 2|current_threshold2 612 and ACT X|current_thresholdX 613. Although five states are illustrated, the state diagram 600 can be three or more states, and can be expandable for an arbitrary number of states, such as greater than five states. Similarly, more or less timeout events may be used and more or less current detect thresholds may be used. ACT X may be equivalent, a subset or superset of ACTY.

The timeouts 601-604 are used to transition between states in one direction, from S0 to S1, S1 to S2, and so on. These timeout events occur when current thresholds have reached certain levels and types of data activity have not been detected for a specified amount of time. The timeouts 601-604 may be chosen such that there is not a premature state transition due to noise or other aberration affecting the current and data signals. Likewise, the timeout period should be sufficiently short to ensure a transition between states in a reasonable amount of time after all detected current and data activity events have come to completion. In addition, the timeouts 601-604 may be chosen such that the energy consumption of the solid-state memory 250 is reduced. The timeout lengths may be calculated using a lower envelope algorithm.

In some embodiments, states 610-650 are associated with AVR 210 output voltages Vout0, Vout1, Vout2, Vout3 and Vout4, respectively. For example, a supply voltage of Vout3 may be provided to the power distribution network 243 and or the solid-state memory 250 when the state machine is in fourth state 640, and a supply voltage of Vout1 may be provided to the power distribution network 243 and or the solid-state memory 250 when the state machine is in the second state 620, etc. In some embodiments, supply voltage Vout0 is greater than or equal to supply voltage Vout1, Vout1 is greater than or equal to supply voltage Vout2, and so on. Alternatively, a reverse convention may be used. In one embodiment, the state machine 600 transitions from a higher state to a lower state in response to detection of data or a current draw that exceeds the corresponding current threshold. The state machine 600 transitions from a lower state to a higher state in response to the corresponding timeout. Of course, the convention on higher and lower states may be reversed based on the design of the state machine 600. As used above, the term “data” refers to a read or write event detected on a data/command bus. ACT1|Current_threshold1 611 of state machine occurs when the current draw of the solid-state memory (as measured by the current draw by the power distribution network) is greater than a first current threshold. This threshold is set to trip on certain activity by the solid-state memory. ACT2|Current_threshold2 612 of state machine 600 occurs when the current draw of the solid-state memory is greater than a second current threshold. This threshold is set to trip on certain other activity by the solid-state memory. ACT3|Current_threshold3 613 of state machine 600 occurs when the current draw of the solid-state memory is greater than a third current threshold. This threshold is set to trip on certain other activity by the solid-state memory. In some embodiments, the first current threshold is greater than the second current threshold, and the second current threshold is greater than the third current threshold.

In one embodiment, the state machine 600 may transition back to the S0 state by disabling the on-demand power management (e.g., !ODP_EN). Once on-demand power management is enabled (e.g. ODP_EN), the state machine 600 can transition to the S1 state after timout0 601. The state machine 600 may transition to the S2 state after a timeout1 602. The state machine 600 can transition back towards a lower number state, such as from third state S2 630 to second state S1 620 in response to detection of certain data (e.g., data activity 1 (ACT1)). For example, the data may include a read or a write event detected on a data/command bus connecting the solid-state memory to the host controller. Alternatively, when the current draw of the solid-state memory has exceeded a predetermined threshold (e.g., current threshold 1) (which may be determined as discussed above with reference to FIG. 4), the state machine 600 may also transition from the third state S2 630 to the second state S1 620. In one embodiment, this means that the current drawn by the power distribution network 243 or the solid-state memory 250 exceeds the first current threshold 611. The third state S2 630 and the second state S1 620 are associated with supply voltages Vout2 and Vout1, respectively. In one embodiment, supply voltage Vout1 is greater than or equal to supply voltage Vout2. Similarly, the state machine 600 may transition from S4 to S3 in response to Act3 or current threshold 3 613, from S3 to S2 in response to Act2 or current threshold 2 612. In some embodiments, this means that the current drawn by the power distribution network 243 or the solid-state memory 250 exceeds the second current threshold 612 or third current threshold 613.

In some embodiments, a time delay may be added to the transition from any one or more of the states 610-650. The time delay may prevent a transition to another state when the requirements for transition are only valid for a short period. The power loss associated with changing states and supply voltages may be greater than the power lost by remaining in the particular state for a longer period than required by the high power event. The length of the time delay may be chosen to balance power savings and latency. The time delay may be calculated using a deterministic or probabilistic lower envelope algorithm.

In another embodiment, the different states of the processor can be written to different voltage regulators across the system. These states can include sleep, power, performance states, such as but not limited to the “S” states of a processor and/or “connected standby.” As would be appreciated by one of ordinary skill in the art having the benefit of this disclosure, the embodiments described herein allows for various combinations of states, thresholds, and timeouts in the state machine operation.

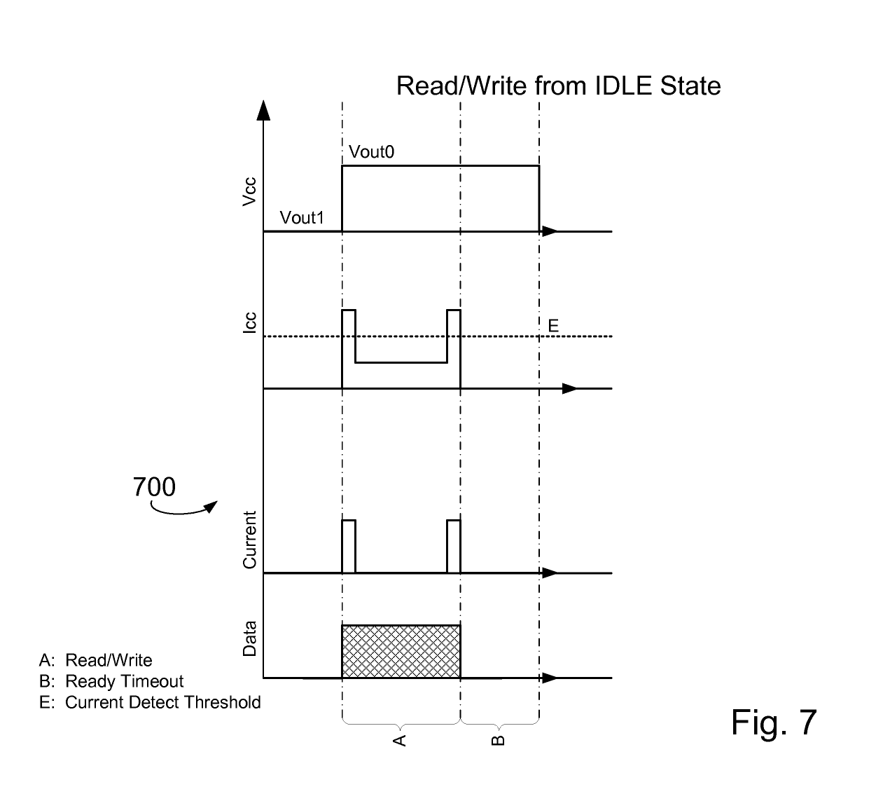

FIG. 7 illustrates one embodiment of a timing diagram 700 related to the state machine 500 of the state diagram illustrated in FIG. 5. During the period before time A of timing diagram 700, the state machine 500 is in the standby state at voltage level Vout1 (as shown in FIG. 5), where no data signal or current is detected. During period A, both current and data are detected and the state machine 500 enters the high power and/or high activity state Vout0.

During period B, no current or data/activity are detected. After a predetermined period, the timeout 501 is met and the state machine 500 returns to the low power and low activity state 520 with the AVR output voltage set to Vout1. The state machine 500 remains in the low power and low activity state 520 until data or current is detected by the PMC.

FIG. 7 illustrates a read or write operation from the idle state: Memory can have stored data. There is a data access operation in ‘A’, which causes Icc to increase, which in turn causes Vcc to increase, improving headroom. In ‘B’, there is no data access (or data access has stopped), causing the current to drop. After a period of time, Vcc will decrease to reduce the headroom.

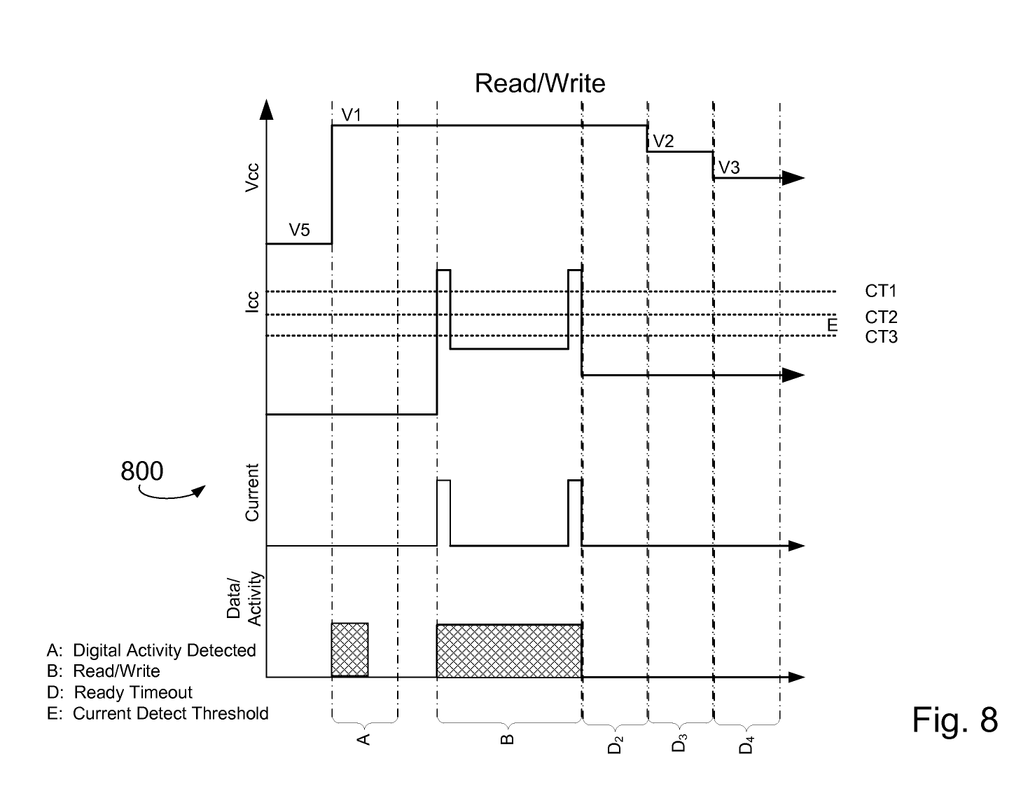

FIG. 8 illustrates one embodiment of a timing diagram 800 related to the state machine 600 of the state diagram illustrated in FIG. 6. From the idle state, digital activity is detected in period A, causing Vcc to increase to V1 as a precursor to the known future activity (and increase/improve the headroom. During the known activity in period B, such as a read operation or a write operation, the current spikes exceed the current threshold (labeled as ‘E’) and keep the system in active state with increased headroom. After some period of time, such as a timeout, Vcc or Vout drops based on the timeout algorithms, such as the on-demand power algorithms shown in FIG. 6, and the Vcc or Vout is reduced to V2 after timeout D₂ (reducing the headroom). After another timeout D₃, Vcc is further reduced to V3.

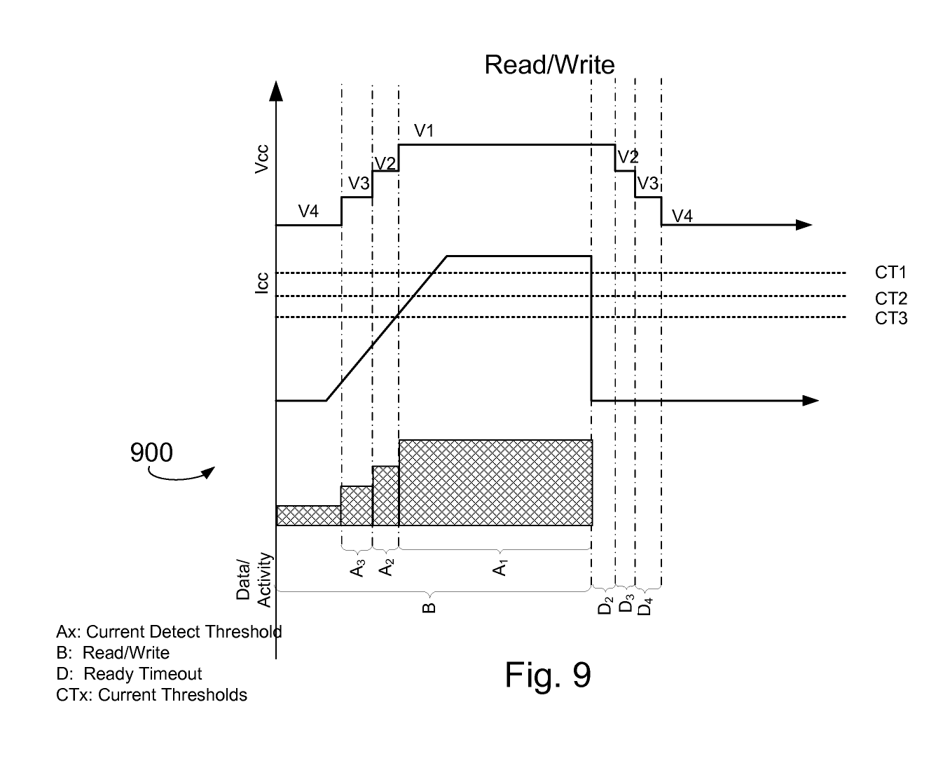

FIG. 9 illustrates another embodiment of a timing diagram 900 related to the state machine 600 of the state diagram illustrated in FIG. 6. From the idle state, digital activity is incrementally increased, causing Vcc to increase from V4 to V3 in period A3, from V3 to V2 in period A2, and from V2 to V1 in period A1 in order to increase/improve the headroom in those periods. During the known activity in period B, such as a read operation or a write operation, the current may also increase incrementally to keep the system in active state with increased headroom. After some period of time, such as a timeout Dₓ, Vcc or Vout drops based on the timeout algorithms, such as the on-demand power algorithms shown in FIG. 6, and the Vcc or Vout is incrementally reduced to V4 upon completion of D₂₋₄ (reducing the headroom). The incremental increase in current can be detected as exceeding the current threshold CT3, CT2 and CT1, respectively.

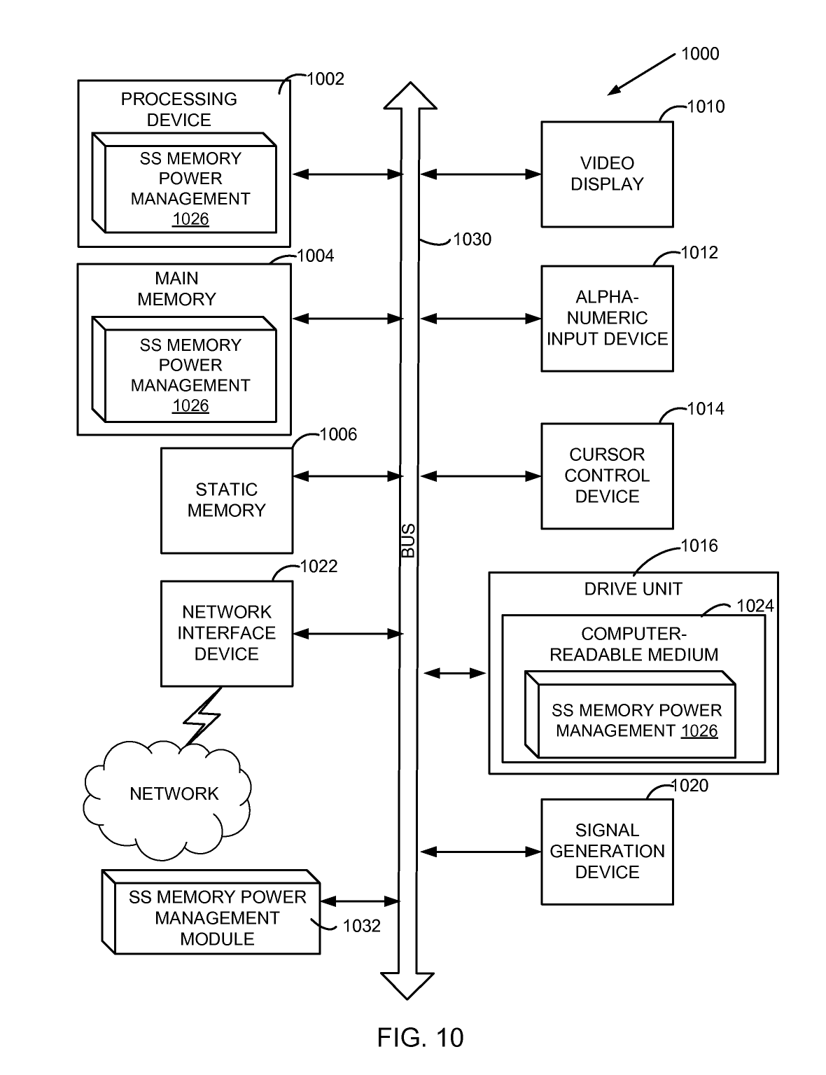

FIG. 10 illustrates a diagrammatic representation of a machine in the exemplary form of a computing system for solid-state memory power management. Within the computing system 1000 is a set of instructions for causing the machine to perform any one or more of the methodologies discussed herein. In alternative embodiments, the machine may be connected (e.g., networked) to other machines in a LAN, an intranet, an extranet, or the Internet. The machine may operate in the capacity of a server or a client machine in a client-server network environment, or as a peer machine in a peer-to-peer (or distributed) network environment. The machine may be a PC, a tablet PC, a set-top-box (STB), a personal data assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein for decoding software-based power management states, such as the methods described above. In one embodiment, the computing system 1000 represents a system in which the power management controller (PMC) described with respect to FIGS. 2-6 can be utilized for solid-state memory power management. For example, the various embodiments described herein may be implemented in the solid-state memory power management module 1032 as described in more detail below. In another embodiment, the computing system 1000 represents various components that may be implemented in the PMC itself. For example, the PMC may have a processing device that executes instructions 1026 for the solid-state memory power management, main memory storing instructions 1026 for the solid-state memory power management, or other computer-readable storage medium 1024 for storing instructions 1026 for the solid-state memory power management as described herein. Alternatively, these devices may include more or less components as illustrated in the computing system 1000.

The exemplary computing system 1000 includes a processing device 1002, a main memory 1004 (e.g., read-only memory (ROM), flash memory, dynamic random access memory (DRAM) such as synchronous DRAM (SDRAM), etc.), a static memory 1006 (e.g., flash memory, static random access memory (SRAM), etc.), and a data storage device 1016, each of which communicate with each other via a bus 1030.

Processing device 1002 represents one or more general-purpose processing devices such as a microprocessor, central processing unit, a microcontroller, or other processing elements. More particularly, the processing device 1002 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1002 may also be one or more special-purpose processing devices such as an application specific integrated circuit (ASIC), a field programmable gate array (FPGA), a digital signal processor (DSP), network processor, or the like. The processing device 1002 is configured to execute the processing logic (e.g., solid-state memory power management 1026) for performing the operations and steps discussed herein. In the embodiments, where the processing device 1002 is the processing device of the PMC, the computing system 1000 may include a host controller or host processor (not illustrated) coupled to the PMC as described with respect to FIG. 2.

The computing system 1000 may further include a network interface device 1022. The computing system 1000 also may include a video display unit 1010 (e.g., a liquid crystal display (LCD) or a cathode ray tube (CRT)), an alphanumeric input device 1012 (e.g., a keyboard), a cursor control device 1014 (e.g., a mouse), and a signal generation device 1020 (e.g., a speaker). In some embodiments where the computing system 1000 is the PMC itself, the computing system 1000 may not include some of these user interface devices.

The data storage device 1016 may include a computer-readable storage medium 1024 on which is stored one or more sets of instructions (e.g., solid-state memory power management 1026) embodying any one or more of the methodologies or functions described herein. The solid-state memory power management 1026 may also reside, completely or at least partially, within the main memory 1004 and/or within the processing device 1002 during execution thereof by the computing system 1000, the main memory 1004 and the processing device 1002 also constituting computer-readable storage media. The solid-state memory power management 1026 may further be transmitted or received over a network via the network interface device 1022.

While the computer-readable storage medium 1024 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing a set of instructions for execution by the machine and that causes the machine to perform any one or more of the methodologies of the present embodiments. The term “computer-readable storage medium” shall accordingly be taken to include, but not be limited to, solid-state memories, optical media, magnetic media, or other types of mediums for storing the instructions. The term “computer-readable transmission medium” shall be taken to include any medium that is capable of transmitting a set of instructions for execution by the machine to cause the machine to perform any one or more of the methodologies of the present embodiments.

The solid-state memory power management module 1032, components, and other features described herein (for example in relation to FIGS. 2-9) can be implemented as discrete hardware components or integrated in the functionality of hardware components such as ASICS, FPGAs, DSPs, or similar devices. The solid-state memory power management module 1032 may implement operations of a method as described herein with respect to state machines described with respect to FIGS. 5-6. In addition, the solid-state memory power management module 1032 can be implemented as firmware or functional circuitry within hardware devices. Further, the solid-state memory power management module 1032 can be implemented in any combination hardware devices and software components.

While particular elements, embodiments and applications of the present invention have been shown and described, it is understood that the invention is not limited thereto because modifications may be made by those skilled in the art, particularly in light of the foregoing teaching. It is therefore contemplated by the appended claims to cover such modifications and incorporate those features, which come within the spirit and scope of the invention.

It should be appreciated that references throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention. In addition, while the invention has been described in terms of several embodiments, those skilled in the art will recognize that the invention is not limited to the embodiments described. The embodiments of the invention can be practiced with modification and alteration within the scope of the appended claims. The specification and the drawings are thus to be regarded as illustrative instead of limiting on the invention.

What is claimed is:

1. An apparatus comprising:
a power detection circuit coupled to a solid-state memory to detect a demand of a power distribution network that supplies power to the solid-state memory; and
a power management controller coupled to the power detection circuit to receive the demand and to scale a voltage supply to the power distribution network in response to the demand.

2. The apparatus of claim 1, further comprising an adjustable voltage regulator coupled to the power management controller to adjust an output voltage in response to control signals from the power management controller.

3. The apparatus of claim 1, wherein the power management controller comprises a circuit to monitor data on a bus coupling the solid-state memory and a host controller of the solid-state memory.

4. The apparatus of claim 1, wherein the power detection circuit comprises a threshold comparator to compare the current drawn by the power distribution network coupled to the solid-state memory with a threshold.

5. The apparatus of claim 1, wherein the power detection circuit is configured to detect a lack of digital activity that allows the solid-state memory to be put in a lower power state.

6. The apparatus of claim 4, wherein the power detection circuit comprises:
a resistive type element coupled between the solid-state memory and the voltage supply; and
a voltage comparator to compare a voltage across the resistive type element against a threshold voltage and to output a current detect signal based on the result of comparing the voltage across the resistive type element and the threshold voltage.

7. The apparatus of claim 1, wherein the power management controller comprises a state machine to transition between a plurality of states in response to the demand detected by the power detection circuit, wherein the plurality of states are associated with a plurality of operation states of the solid-state memory.

8. The apparatus of claim 1, wherein the solid-state memory is a synchronous dynamic random access memory (SDRAM).

9. The apparatus of claim 1, wherein the solid-state memory is a graphic synchronous dynamic random access memory (graphic SDRAM).

10. The apparatus of claim 1, wherein the solid-state memory is a low power version of synchronous dynamic random access memory (SDRAM).

11. The apparatus of claim 1, wherein the solid-state memory is a flash memory.

12. The apparatus of claim 1, wherein the solid-state memory is a magnetoresistive random-access memory (MRAM).

13. A method comprising:
detecting a demand of a power distribution network that supply power to a solid-state memory; and
scaling a voltage supply to the power distribution network in response to the detected demand.

14. The method of claim 13, further comprising defining a plurality of states, each of the plurality of states associated with an operation state of the solid-state memory.

15. The method of claim 14, further comprising transitioning between the plurality of states in response to the detected demand.

16. The method of claim 14, further comprising transitioning between the plurality of states in response to a timeout.

17. A non-transitory, computer-readable storage medium including instructions that, when executed by a processor, cause the processor to perform operations comprising:
detecting a demand of a power distribution network that supply power to a solid-state memory; and
scaling a voltage supply to the power distribution network in response to the detected demand.

18. The computer-readable storage medium of claim 17, wherein the operations further comprise defining a plurality of states, each of the plurality of states associated with an operation state of the solid-state memory.

19. The computer-readable storage medium of claim 17, wherein the operations further comprise transitioning between the plurality of states in response to the detected demand.

20. The computer-readable storage medium of claim 17, wherein the operations further comprise transitioning between the plurality of states in response to a timeout.
